(19) United States
(12) Patent Application Publication
(10) Pub. No.: US 2010/0028843 A1
(43) Pub. Date: Feb. 4, 2010

(54) SPEECH ACTIVATED SOUND EFFECTS BOOK

(75) Inventors: Jeffrey W. Currington, Corinth, TX (US); Cameron S. Currington, Corinth, TX (US)

Correspondence Address: RAYMOND A. HUTCHINSON, 3833 WENONOB, BERWYN, IL, 60402, US

(73) Assignee: Bonafide Innovations, LLC, Corinth, TX (US)

(21) Appl. No.: 12/181,988

(22) Filed: Jul. 29, 2008

(51) Int. Cl. G09B 5/00

(52) U.S. Cl. 434/317

(57) ABSTRACT

A speech activated book having a cover disposed to receive an elongated housing. The speech-activated book could also include at least one page disposed along a portion of a binding area of the book. The page includes text having at least one trigger word. The speech-activated book could also include an audio circuit that, in response to detecting an audible representation of the trigger word, could provide an associated sound effect stored in memory. The elongated housing could be secured to the cover by at least one of: glue, an adhesive, a heat-set binding, a screw, a tab, a wire, a spiral connector, a rivet, a staple, a fastener, and a retainer.

The disclosure relates generally to reading materials, and in particular to books having some form of interactivity.

### BACKGROUND

Reading and being read to are favorite past times for both adults and children of all ages. What is needed is an interactive book to provide entertainment and/or educational information through the use of sound.

### SUMMARY

Embodiments of the present disclosure generally provide systems and methods for speech activated sound effects books and related material.

In one embodiment, the present disclosure generally provides an interactive book. The book could include a cover disposed to receive an elongated housing along a binding area. The elongated housing could include an audio circuit and a power circuit. The book could also include at least one page disposed along a portion of the binding area. The page could include text having at least one trigger word. In response to detecting a trigger word, the audio circuit could provide an associated sound effect.

In one embodiment, the present disclosure provides, a method of sound activation for use in conjunction with a book. The method could include detecting a spoken trigger word in an audio circuit. The audio circuit could be disposed in an elongated housing along a binding area of a cover of the book. The elongated housing could include an audio circuit and a power circuit. The method could also include, in response to detecting a trigger word, providing an associated sound effect.

In one embodiment, the present disclosure provides a speech-activated book. The speech-activated book could include a cover disposed to receive an elongated housing. The speech-activated book could also include at least one page disposed along a portion of a binding area of the book. The page includes text having at least one trigger word. The speech-activated book could also include an audio circuit that, in response to detecting an audible representation of the trigger word, could provide an associated sound effect stored in memory.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 is an exemplary view of a book according to one embodiment of the present disclosure;

FIG. 2 is another exemplary view of the book shown in FIG. 1 according to one embodiment of the present disclosure;

FIG. 3 is still another exemplary view of the book shown in FIG. 1 according to one embodiment of the present disclosure;

FIG. 4 is an exemplary view of a book according to one embodiment of the present disclosure;

FIG. 5 is another exemplary view of the book shown in FIG. 4 according to one embodiment of the present disclosure;

FIG. 6 is an exemplary view of a book according to one embodiment of the present disclosure;

FIG. 7 is another exemplary view of the book shown in FIG. 6 according to one embodiment of the present disclosure;

FIG. 8 is still another exemplary view of the book shown in FIG. 6 according to one embodiment of the present disclosure;

FIG. 9 is a somewhat simplified block diagram illustrating the components of a book according to one embodiment of the present disclosure; and

FIG. 10 is a somewhat simplified flow diagram illustrating a method of providing a speech activated sound effects book according to one embodiment of the present disclosure.

### DETAILED DESCRIPTION

The present disclosure generally relates to reading materials and, in particular, to books that provide some form of interactivity.

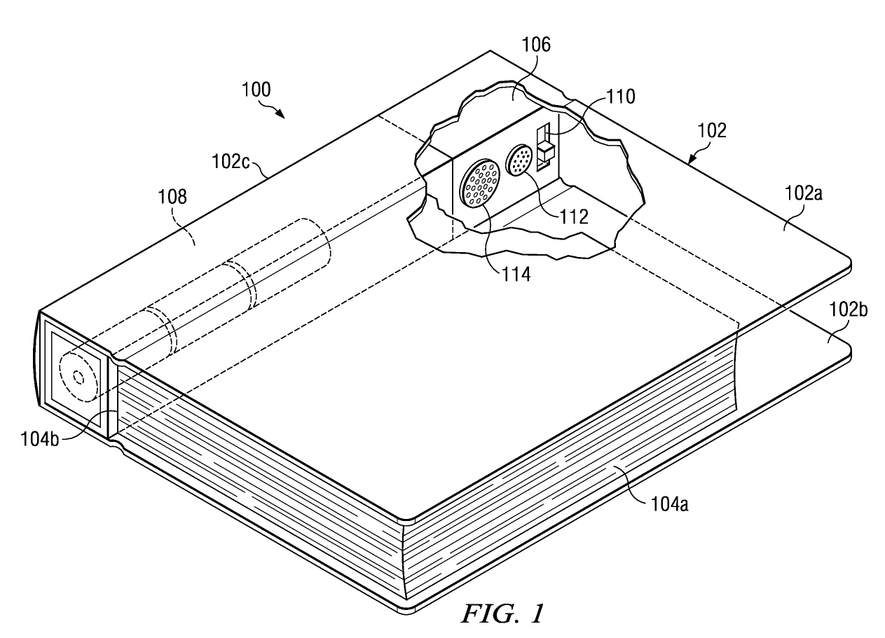

FIG. 1 is a perspective view of a book 100 in according to one embodiment of the present disclosure. Book 100 is generally shown in FIG. 1 in the “closed position.” The embodiment of book 100 shown in FIG. 1 is for illustrative purposes only. It should be understood that other embodiments could also be used in accordance with the present disclosure.

Book 100 could include text, illustrations, objects, or any other suitable material that describes a story, series of stories, poem, educational material, collection of thoughts, other suitable material, or any combination thereof. Book 100 has the capability to generate sound effects, background music, speech, other sounds, or any suitable combination thereof when activated by a reader's spoken word, phrase, or other sound elicited by the book as described in detail herein. Book 100 could also have the capability of recognizing words or phrases in speaker independent or speaker dependent modes. In addition, book 100 could further have the capability to recognize foreign languages.

Book 100 preferably includes a cover 102 having pages 104a bound to cover 102. Cover 102 could generally include a front portion 102a, a back portion 102b, and a spine portion 102c as shown in FIG. 1.

In one embodiment, cover 102 could be a continuous sheet of material. In other embodiments, cover 102 could include three physically separated portions where, for example, front portion 102a, back portion 102b, and spine portion 102c are connected or otherwise bound together by a suitable connector or bounding mechanism. In still other embodiments, cover 102 could include two physically separated portions where, for example, front portion 102a and spine portion 102c are part of a continuous sheet of material and the back portion 102b is connected or otherwise bound together by a suitable connector or bounding mechanism.

In yet other embodiments, cover 102 could include two physically separated portions where, for example, back portion 102b and spine portion 102c are part of a continuous sheet of material and the front portion 102a is connected or otherwise bound together by a suitable connector or bounding mechanism. It should be understood that any suitable relative arrangement for cover 102 (with respect to front portion 102a, back portion 102b, and spine portion 102c) could be used in accordance with the present disclosure.

Front portion 102a, back portion 102b, and spine portion 102c (sometimes collectively referred to herein as “cover 102”) could be made of or include paper, cardboard, plastic, flexible film, electrical circuitry, any other suitable material or polymer, or any combination thereof. Each of front portion 102a, back portion 102b, and spine portion 102c may be made of different materials and each may include different materials, thicknesses, dimensions, sizes, shapes, or finishes.

Cover 102 could house any number of suitable pages 104a as shown in FIG. 1. Each of pages 104a could be made of or include paper, cardboard, plastic, flexible film, electrical circuitry, any other suitable material or polymer, or any combination thereof. Each of pages 104a is optionally bound to another of pages 104a by a binding 104b. Pages 104a (or, in some cases, binding 104b) is bound to cover 102 through spine portion 102c. Although cover 102 is illustrated in FIG. 1 as having a dimension slightly larger than pages 104a, it should be understood that the sizes of cover 102 and pages 104a could exhibit any suitable relative dimension. For example, cover 102 and pages 104a could have substantially the same dimension or perhaps drastically different relative dimensions, depending on the style and look desired of book 100.

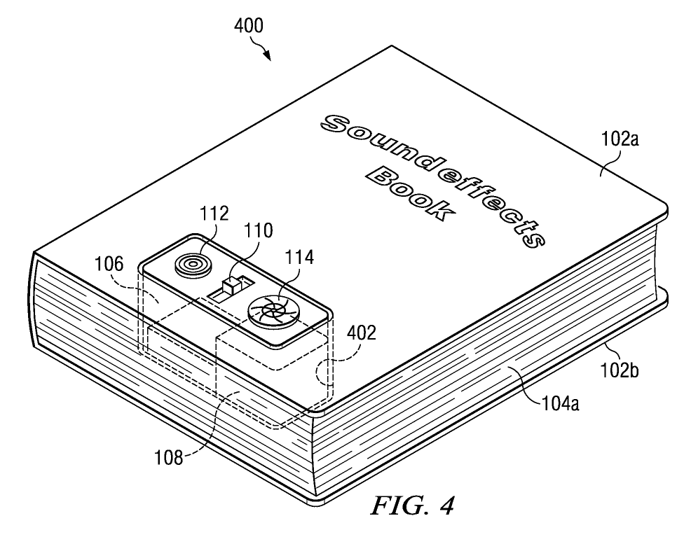

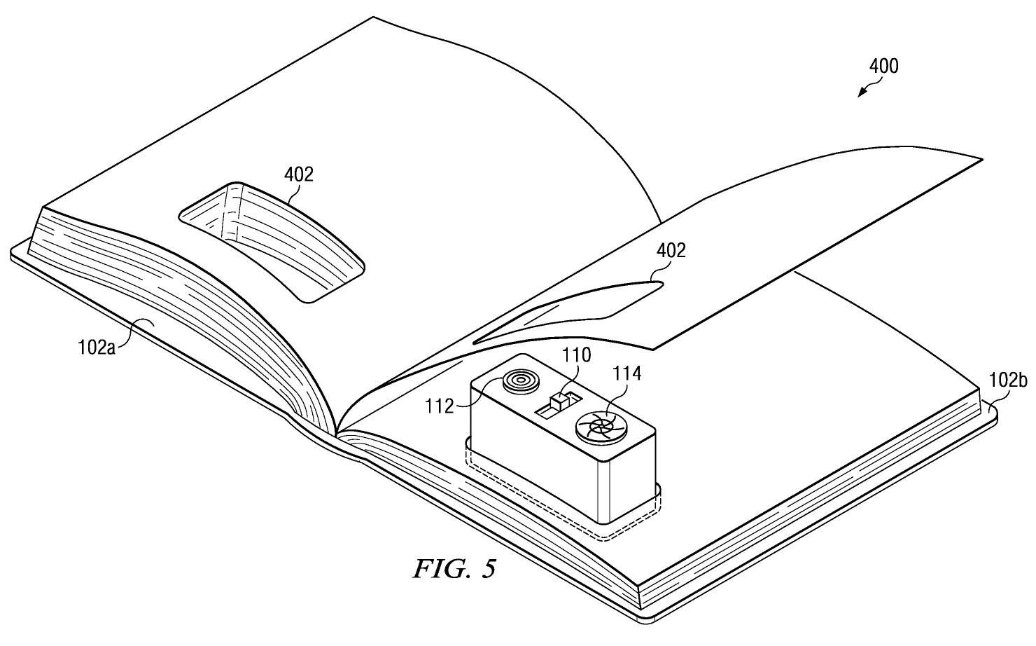

In one embodiment, spine portion 102c includes circuitry compartment 106. Preferably, circuitry compartment 106 includes circuitry (not shown in FIG. 1, but generally described in detail later herein in conjunction with the descriptions accompanying FIGS. 4 and 5) to aid in carrying out some of the functional aspects of book 100. The circuitry could include a single printed circuit board (PCB), a set of PCB's, or any other suitable circuitry.

Circuitry compartment 106 is preferably a stand-alone housing and could be inserted into spine portion 102c and otherwise attached or fastened to cover 102. Circuitry compartment 106 could be made of any suitable material including, for example, paper, cardboard, plastic, flexible film, any other suitable material or polymer, or any combination thereof. Preferably, access to circuitry compartment 106 is readily ascertainable and without entirely deconstructing spine portion 102c. It should be understood that any number of suitable mounting and/or retaining mechanisms may be used to attach, secure, and/or access circuitry compartment 106. Accordingly, circuitry compartment 106 (and any associated circuitry) could be fastened or otherwise attached or inserted into book 100 using any suitable method using minimal tooling changes, thus reducing the cost of manufacturing.

Spine portion 102c could also include battery compartment 108. Battery compartment 108 preferably houses a power supply to power circuitry housed in circuitry compartment 106 and any other suitable circuitry associated with book 100. Battery compartment 108 could house any suitably sized DC battery. It should be understood that that the use of battery compartment 108 is optional and that book 100 could be powered using an AC power supply, DC power supply, a solar power supply, any other suitable power supply, or any combination thereof. Battery compartment 108 could be made of any suitable material including, for example, paper, cardboard, plastic, flexible film, any other suitable material or polymer, or any combination thereof. It should also be understood that any number of suitable mounting and/or retaining mechanisms may be used to attach, secure, and/or access battery compartment 106. In addition, it should be understood that battery compartment 106 could be configured to recharge any batteries housed within it.

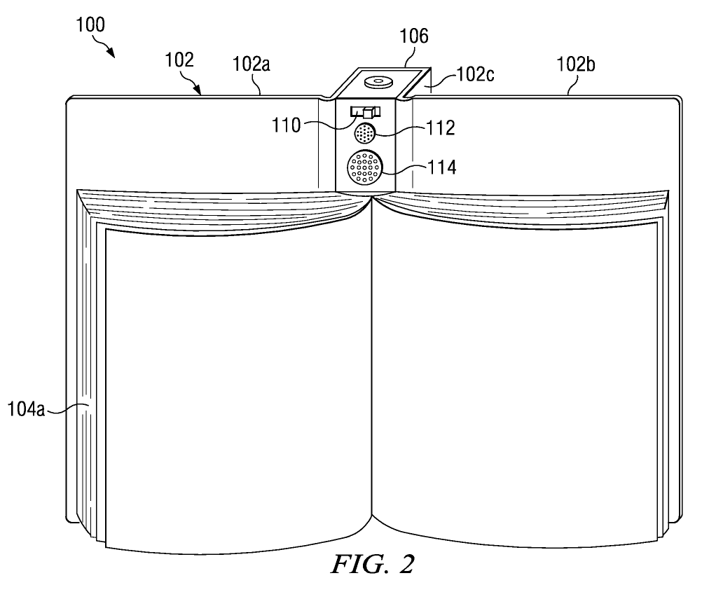

FIG. 2 is another perspective view of book 100 according to one embodiment of the present disclosure. In particular, book 100 is shown in a generally “open” position. In addition, to some of the elements described above in conjunction with FIG. 1, FIG. 2 also illustrates a switch 110, microphone 112, speaker 114, and output jack 116.

Switch 110 could include a switch for use as a power switch, operation mode switch, control switch, or any other suitable switch. For example, switch 110 could include positions for power on, power off, stand-by, mute, other suitable functions, or any combination thereof. Although FIG. 2 illustrates switch 110 as a generally rectangular shaped structure located in a particular location on book 100, it should be understood that switch 110 could be any suitable shape or form and located in any suitable location on book 100. In addition, it should be understood that switch 110 could be rotary switch, push-button style, touch sensitive, heat-sensing, motion-detecting, two-way, three-way, any other suitable switch, or any combination thereof.

Microphone 112 could include any sound receiving or capturing device for aiding in sensing sound, amplifying sound, performing other suitable functions, or any combination thereof. Although FIG. 2 illustrates microphone 112 as a generally round entity located in a particular location on book 100, it should be understood that microphone 112 could be any suitable shape or form and in any suitable location on book 100. It should also be understood that microphone 112 could be adjusted to sense sounds at a particular threshold, level, pitch, or volume. It should further be understood that microphone 112 could be a separate entity or physically combined with speaker 114. In addition, it should be understood that microphone 112 could be any suitable wireless microphone having an associated receiving mechanism in communication with book 100 (and, in particular, any associated circuitry housed in book 100).

Speaker 114 could include any sound emitting device for aiding in projecting sound, amplifying sound, performing other suitable functions, or any combination thereof. Although FIG. 2 illustrates speaker 114 as a generally round entity located in a particular location on book 100, it should be understood that speaker 114 could be any suitable shape or form and in any suitable location on book 100. It should also be understood that speaker 114 could be adjusted to emit sounds at a particular threshold, level, pitch, or volume. It should also be understood that speaker 114 could be a separate entity or physically combined with microphone 112.

Output jack 116 could include any suitable connection for projecting sound, amplifying sound, performing other suitable functions, or any combination thereof. In particular, output jack 116 could provide connectivity to an external speaker (not shown) to aid in, for example, projecting sound to an audience. Although FIG. 2 illustrates output jack 116 as a generally round entity or connection point located in a particular location on book 100, it should be understood that output jack 116 could be any suitable shape or form and in any suitable location on book 100. It should also be understood that the output of output jack 116 could be adjusted to emit sounds at a particular threshold, level, pitch, or volume.

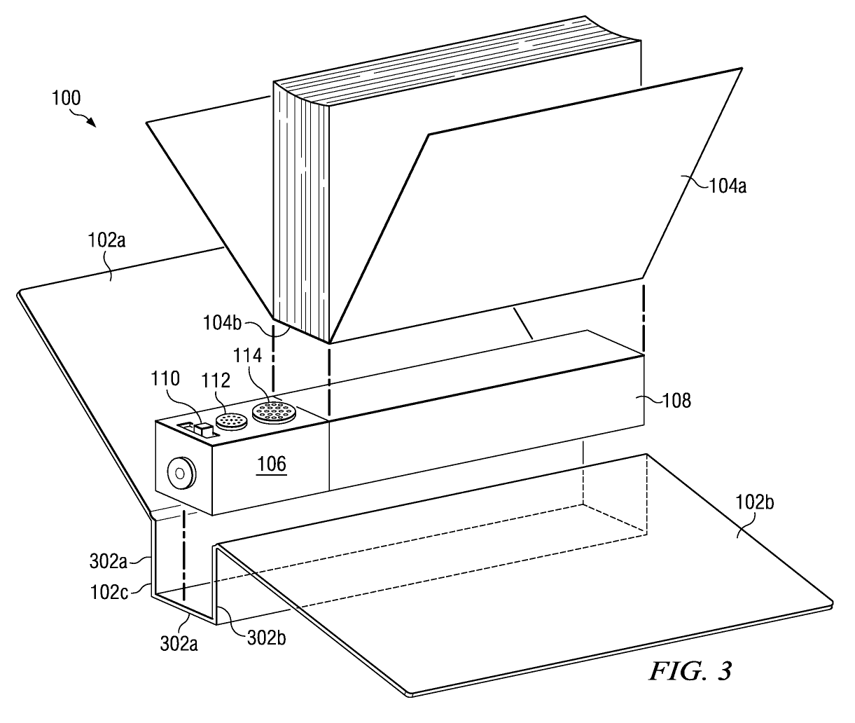

FIG. 3 is an expanded view of book 100 according to one embodiment of the present disclosure. In particular, FIG. 3 illustrates exemplary positions of, for example, cover 102, front portion 102a, back portion 102bk, spine portion 102c, pages 104a, binding 104b, circuitry compartment 106, and battery compartment 108. The relative positions and dimensions of each element shown in FIG. 3 are exemplary. Any suitable position and/or dimension may be used.

In one embodiment, the present disclosure provides book 100 having cover 102 configured to fit circuitry compartment 106 and battery compartment 108. As one example, cover 102 could be crimped, cut, folded, formed or otherwise prepared to make a binding area having a first portion 302a, a second portion 302b and a third portion 302c (sometimes collectively referred to herein as “binding area 302”).

Binding area 302 could include glue, adhesive, heat-set bindings, screws, tabs, wire, spiral connectors, rivets, staples, other suitable fasteners and retainers, or any combination thereof to secure circuitry compartment 106 and battery compartment 108 to binding area 302. It should be understood that any suitable method of securing circuitry compartment 106 and battery compartment 108 to binding area 302 could be used in accordance with the present disclosure.

Similarly, binding 104b (or each of pages 104a) is secured to a surface or portion of a surface of (either or both of) circuitry compartment 106 and battery compartment 108 by glue, adhesive, heat-set bindings, screws, tabs, wire, spiral connectors, rivets, staples, other suitable fasteners and retainers, or any combination.

FIGS. 4 and 5 are exemplary views of book 400 according to one embodiment of the present disclosure. Book 400 is similar to book 100 described above and shown in FIGS. 1, 2, and 3. However, circuitry compartment 106 and battery compartment 108 could be disposed within the pages of book 400 as shown. For example, pages 104a could be configured with an aperture 402 as shown in FIGS. 4 and 5 to allow circuitry compartment 106 and battery compartment 108 to be disposed within aperture 402. Circuitry compartment 106 and battery compartment 108 could be optionally removed to fit into another book 400. Circuitry compartment 106 could include a sensor (not shown) or other circuit to recognize book 400 and to correlate the information with the correct story and sound effects associated with that particular book 400. In that way, circuitry compartment 106 and battery compartment 108 could be a stand-alone unit removable for use in many different books 400.

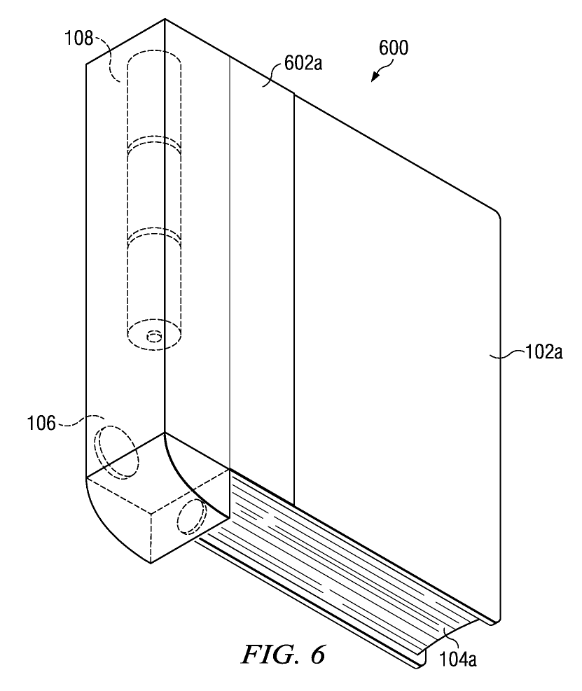

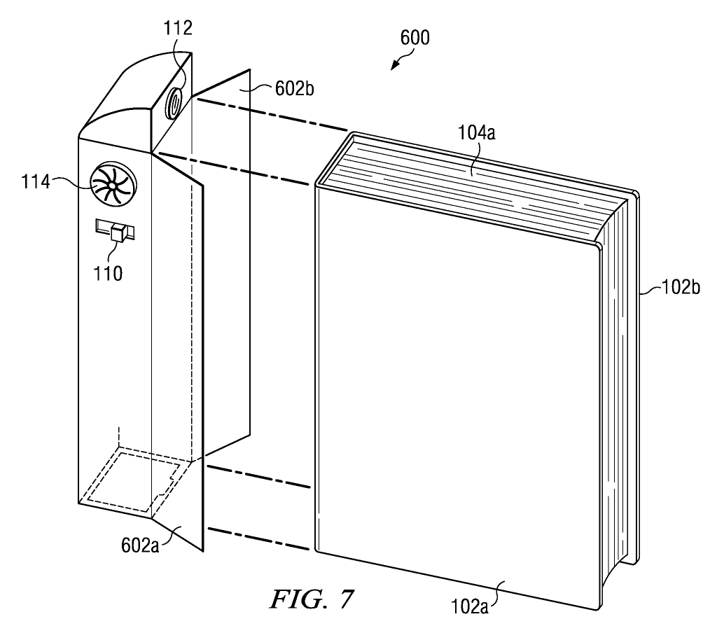

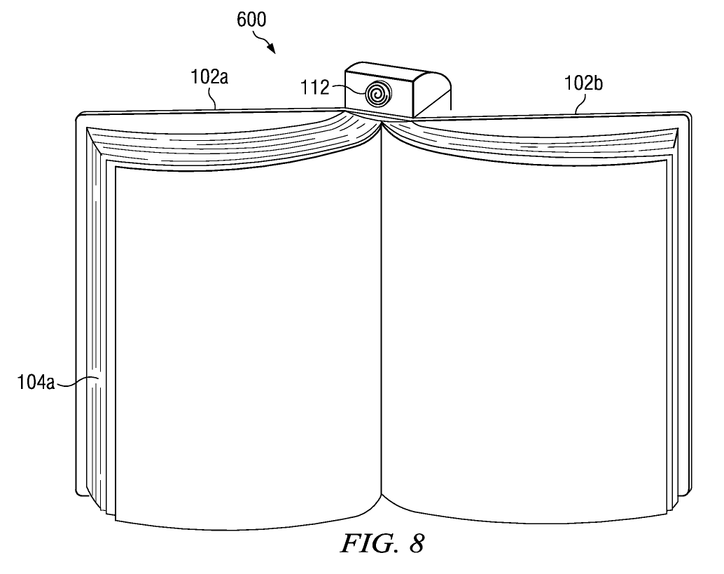

FIGS. 6, 7, and 8 are exemplary view of book 600 according to one embodiment of the present disclosure. Book 600 is similar to book 100 described above and shown in FIGS. 1, 2, and 3. However, circuitry compartment 106 and battery compartment 108 are bound to the spine of book 600 using flaps 602a and 602b. In one embodiment, circuitry compartment 106 and battery compartment 108 could be optionally removed to fit into another book 600 using flaps 602a and 602b. Flaps 602a and 602b could be bound to book 600 using, for example, glue, an adhesive, a heat-set binding, hook and loop fastener, a screw, a tab, a wire, a spiral connector, a crimp, a rivet, a staple, a fastener, a retainer, any suitable material, or combination thereof. Circuitry compartment 106 could include a sensor (not shown) or other circuit to recognize book 600 and to correlate the information with the correct story and sound effects associated with that particular book 600. In that way, circuitry compartment 106 and battery compartment 108 could be a stand-alone unit removable for use in many different books 600.

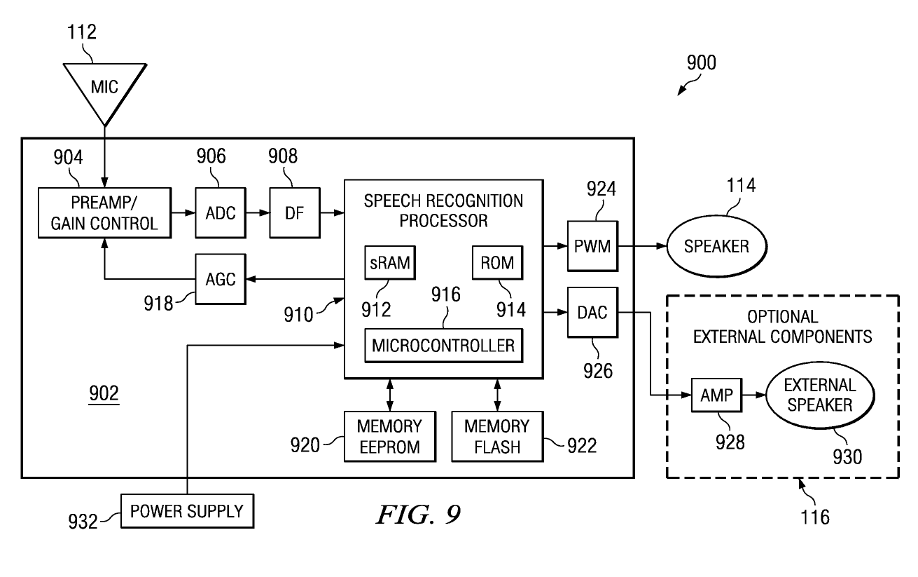

FIG. 9 is a somewhat simplified block diagram illustrating system 900 according to one embodiment of the present disclosure. System 900 generally includes circuitry associated with the operation of book 100 and could be housed in circuitry compartment 106 shown in, for example, FIGS. 1, 2, and 3. System 900 shown in FIG. 9 is for illustrative purposes only. Other suitable systems, modules, or other suitable circuits may be used in accordance with the present disclosure.

System 900 includes an integrated circuit (IC) 402 coupled to microphone 112 (described earlier in the description accompanying FIGS. 2 and 3). IC 902 shown in FIG. 9 is illustrative purposes only. Other processors, systems, modules, or other suitable circuits may be used in accordance with the present disclosure.

Microphone 112 captures sounds input by someone associated with book 100 (e.g., either a reader or an active listener) and outputs an associated analog signal to IC 902. Microphone 112, as described earlier, could include any sound capturing device for aiding in sensing sound, amplifying sound, performing other suitable functions, or any combination thereof. Preferably, microphone 112 could include a unidirectional microphone or other microphone capable of focusing its reception direction in front of a reader of book 100.

In one embodiment, IC 902 could process the associated signal using a preamplifier/gain control circuit 904. Preamplifer/gain control circuit 904 is coupled to analog to digital converter (ADC) 906 which, in turn, is coupled to digital filter circuit (DF) 908.

DF circuit 908 eliminates or reduces any unwanted background noise. It should be understood that any noise eliminating or reducing system, processor, filter, or other suitable circuit could be used as DF circuit 908. DF circuit 908 is coupled to a speech recognition processor 910.

Speech recognition processor 910 generally recognizes speech, spoken utterances or other sounds captured or otherwise input into microphone 112 and generally outputs an associated sound effect. The associated sound effect could be any pre-stored sound or series of sounds in the form of a converted wav file, MIDI file, an MP3 file, any combination thereof, or any other suitably stored form. Speech recognition processor 910 could include static read access memory (sRAM) 912, read only memory (RON) 914, and microcontroller 916. Microcontroller 916 could have several functions including, for example, generally controlling sRAM 912, ROM 914, and directing processes in system 900.

Speech recognition processor 910 also generally controls the automatic gain control (AGC) 918. AGC 418 generally normalizes the digital signal. AGC 918 could include any suitable circuitry to accomplish this task. AGC 918 is coupled to preamplifier/gain control 904 described earlier herein. In addition, speech recognition processor 910 is coupled to EEPROM memory 920 and flash memory 922.

Depending on the input from microphone 112, speech recognition processor 910 outputs a signal to pulse width modulator (PWM) 924 and then in turn to speaker 114. PWM 924 could include or be replaced with a digital-to-analog converter (DAC). As described earlier, speaker 114 could include any sound emitting device for aiding in projecting sound, amplifying sound, performing other suitable functions, or any combination thereof.

Alternatively, if output jack 116 is connected to an external speaker 930, speech recognition processor 910 will output a signal to digital to analog converter (DAC) 926 and then in turn to external speaker 930. It should be understood that speech recognition processor 410 could, in certain circumstances, output a signal to both speaker 114 and external speaker 930 concurrently and at different threshold levels.

IC 902 is generally powered by power supply 932. Power supply 932 could be batteries or any other suitable power source stored in battery compartment 108 or other readily available location. It should be understood that IC 902 could be powered using an AC power supply, DC power supply, a solar power supply, any other suitable power supply, or any combination thereof.

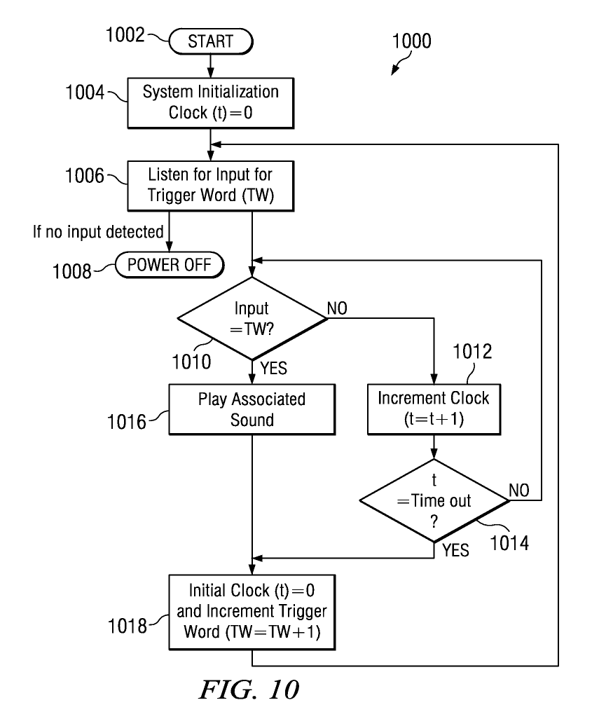

FIG. 10 is a somewhat simplified flow diagram illustrating method 1000 for generally providing a speech activated sound effects book according to one embodiment of the present disclosure. Method 1000 is illustrative of one method of providing a speech activated sounds effect book. It should be understood that method 1000 could include other steps in lieu of on in conjunction with the steps described herein according to other embodiments of the present disclosure.

Method 1000 initiates when a user powers on or otherwise initializes the book in step 1002. For example, according to one embodiment, a user could use switch 110 to power up or turn on book 100. Alternatively, book 100 could power on (or power off) after sensing a particular sound. After the book 100 receives power, a microprocessor enters an initialization mode in step 1004 and initializes the clock (t=0). In one embodiment, for example, after book 100 receives power, speech recognition processor 910 initializes and sets an internal clock to an initial time(t) or t=0.

In step 1006, method 1000a continues and the “book” listens for any incoming speech, spoken utterances or other suitable sounds from the user or audience that matches a predetermined trigger word (TW). For example, in one embodiment, the user's voice (or audience member's voice) is captured or otherwise input into microphone 112 and processed by speech recognition processor 910. If no sound or other suitable activity is detected after a predetermined amount of time, book 100 could power down using an automatic time delayed “shut-off” mechanism in step 1008.

If, however, a sound is detected in step 1006, method 1000 continues and the “book” listens for any trigger words or predetermined sounds input by the user (or audience member) in step 1010. If the trigger word is not detected, method 1000 increments the clock in step 1012 and determines if the clock has run to a predetermined time out period (or time out factor) in step 1014. If there is still time remaining, method 1000 returns to step 1010 to continue to listen for trigger word or predetermined sound.

If, however, a trigger word is indeed detected or otherwise recognized in step 1010, the “book” plays a corresponding sound or predetermined sound with respect to the trigger word detected in step 1016. In step 1018, the clock is again initialized and the next trigger word (TW=TW+1) is set for listening in step 1006. It should be understood that each trigger word (TW) may be set forth or determined using a look up table or other data managing system within book 100 or, more specifically, in memory 920 or 922.

As an example, suppose when reading the text: “When it started to rain, Johnny let his dog in the house,” book 100 could be programmed to recognize the trigger words: “rain” and “dog.” After detecting the word “rain”, an associated sound resembling rain or a rain storm could be activated using a look up table or other data managing system in memory. As another example, after detecting the word “dog”, an associated sound resembling a dog's bark could be activated. It should be understood, however, that any sound may be activated by a trigger word or phrase and preprogrammed to do so accordingly.

Accordingly, in one embodiment, the present disclosure provides a voice controlled book and words that generate wound effects, background music, melodies, or any combination thereof activated by words and/or phrases embedded within the text or storyline. Book 100 generally includes low-cost speech or voice recognition microcontrollers or microprocessors programmed with linking vocabularies of words or phrases that activate sound effects and/or music.

In one embodiment, the recognition word(s) or phrases are specific for each story as are the appropriate sound effects or music. Each book 100 provides a low cost working product and could generally be a hands-off, out-of-the-box novelty for entertaining the reader with speech activated sound effects and/or music, and customized or choreographed at their reading speed.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An interactive book comprising:
a cover disposed to receive an elongated housing along a binding area, the elongated housing having an audio circuit and a power circuit; and
at least one page disposed along a portion of the binding area, wherein the page comprises text having at least one trigger word, and wherein, in response to detecting a trigger word, the audio circuit provides an associated sound effect.

2. The book of claim 1, wherein the audio circuit comprises a processor to detect the trigger word from an input.

3. The book of claim 1, wherein the audio circuit comprises a memory having a plurality of trigger words.

4. The book of claim 3, wherein the memory comprises a corresponding associated sound effect for each of the trigger words.

5. The book of claim 1, wherein the audio circuit comprises a speaker to output the associated sound.

6. The book of claim 1, wherein the audio circuit comprises a microphone to detect inputs.

7. The book of claim 1, wherein the elongated housing is secured to the cover by at least one of: glue, an adhesive, a heat-set binding, a screw, a tab, a wire, a spiral connector, a rivet, a staple, a fastener, and a retainer.

8. The book of claim 1, wherein the power circuit comprises a battery.

9. The book of claim 1, wherein the power circuit comprises a power off mechanism triggered by inactivity.

10. For use in conjunction with a book, a method of sound activation, the method comprising:
detecting a spoken trigger word in an audio circuit disposed in an elongated housing along a binding area of a cover of the book, the elongated housing having an audio circuit and a power circuit; and
in response to detecting a trigger word, providing an associated sound effect.

11. The method of claim 10, wherein the audio circuit comprises a processor to detect the trigger word from an input.

12. The method of claim 10, wherein the audio circuit comprises a memory having a plurality of trigger words.

13. The method of claim 12, wherein the memory comprises a corresponding associated sound effect for each of the trigger words.

14. The method of claim 10, wherein the audio circuit comprises a speaker to output the associated sound.

15. The method of claim 10, wherein the audio circuit comprises a microphone to detect inputs.

16. The method of claim 10, wherein the elongated housing is secured to the cover by at least one of: glue, an adhesive, a heat-set binding, a screw, a tab, a wire, a spiral connector, a rivet, a staple, a fastener, and a retainer.

17. The method of claim 10, wherein the power circuit comprises a battery.

18. The method of claim 10 further comprising powering off the book during inactivity.

19. A speech activated book comprising:
a cover disposed to receive an elongated housing;
at least one page disposed along a portion of a binding area of the book, wherein the page comprises text having at least one trigger word; and
an audio circuit, in response to detecting an audible representation of the trigger word, to provide an associated sound effect stored in memory.

20. The book of claim 19, wherein the elongated housing is secured to the cover by at least one of: glue, an adhesive, a heat-set binding, a screw, a tab, a wire, a spiral connector, a rivet, a staple, a fastener, and a retainer.
